(19) United States
(12) Patent Application Publication
(10) Pub. No.: US 2022/0158399 A1
(43) Pub. Date: May 19, 2022

(54) JOINING STRUCTURE AND JOINING METHOD OF TERMINAL AND CABLE

(71) Applicant: YAZAKI CORPORATION, Tokyo (JP)

(72) Inventor: Kenichi Doushita, Shizuoka (JP)

(73) Assignee: YAZAKI CORPORATION, Tokyo (JP)

(21) Appl. No.: 17/454,638

(22) Filed: Nov. 12, 2021

(30) Foreign Application Priority Data
Nov. 16, 2020 (JP) 2020-190253

(51) Int. Cl. H01R 43/048; H01R 11/12

(52) U.S. Cl. CPC H01R 43/048; H01R 11/12

(57) ABSTRACT

A joining structure of a terminal and a cable for joining a core wire exposed from an insulation sheath of a cable to a terminal is provided. In the joining structure, the terminal has a joining surface to which the exposed core wire is joined, the exposed core wire has at least two joining portions, and each of the at least two joining portions is formed by being joined to the joining surface of the terminal by means of pressure-welding.

### CROSS REFERENCE TO RELATED APPLICATION

This application is based on, and claims priority from the prior Japanese Patent Application No. 2020-190253 filed on Nov. 16, 2020, the entire contents of which are incorporated herein by reference.

### TECHNICAL FIELD

The present disclosure relates to a joining structure and a joining method of a terminal and a cable.

### BACKGROUND

JP 2014-211959 A discloses a technique to prevent a core wire from severing when the terminal and the cable are joined.

### SUMMARY

In the technique disclosed in JP 2014-211959 A, a core wire exposed from an insulation sheath of a cable is compressed with a stepped press die to form the exposed core wire portion into a stepped shape. Then, the core wire portion formed in a stepped shape is electrically connected to a terminal by means of ultrasonic joining.

However, in the joining of a terminal and a cable disclosed in JP 2014-211959 A, a press die for forming a core wire exposed from an insulation sheath of a cable into a stepped shape is essential, and this increases the cost. In addition, since the area of a joining portion (a portion at which a terminal and a core wire come into contact with each other) is large, it is difficult to set processing conditions for uniformly joining the entire core wire, and incomplete joining may occur.

An object of the present disclosure is to provide a joining structure and a joining method of a terminal and a cable, which can reduce, at a low cost, fracturing of a core wire and joint failures during joining.

A joining structure of a terminal and a cable according to an embodiment is a joining structure of a terminal and a cable for joining a core wire exposed from an insulation sheath of the cable to the terminal, in which the terminal includes a joining surface to which the exposed core wire is joined, the exposed core wire includes at least two joining portions, and the at least two joining portions are formed by being individually joined to the joining surface of the terminal by means of pressure-welding.

The at least two joining portions may be provided with a predetermined interval therebetween, the predetermined interval being in a longitudinal direction of the exposed core wire.

The height of the joining portion on a distal end side of the at least two joining portions may be formed to be lower than the height of the joining portion on a proximal end side.

A joining method of a terminal and a cable according to another embodiment is a joining method of a terminal and a cable for joining a core wire exposed from an insulation sheath of the cable to the terminal. The method includes pressure-welding and joining an exposed end portion at least on a proximal end side of the exposed core wire to a joining surface at least on a proximal end side of the terminal once by using a welding machine, and then pressure-welding and joining an exposed end portion on a distal end side of the exposed core wire to a joining surface on a distal end side of the terminal twice by using the welding machine.

When the exposed end portion on the proximal end side of the exposed core wire is pressure-welded to the joining surface on the proximal end side of the terminal, the exposed end portion on the distal end side of the exposed core wire is simultaneously pressure-welded to the joining surface on the distal end side of the terminal once by using the welding machine, and thereafter the exposed end portion on the distal end side of the exposed core wire that has been pressure-welded once to the joining surface on the distal end side of the terminal may be pressure-welded and joined to the joining surface once again by using the welding machine.

After the exposed end portion on the proximal end side of the exposed core wire is pressure-welded to the joining surface on the proximal end side of the terminal once by using the welding machine, the exposed end portion on the distal end side of the exposed core wire may be pressure-welded and joined to the joining surface on the distal end side of the terminal twice continuously by using the welding machine.

The exposed end portion of the exposed core wire may be joined to the joining surface of the terminal by means of any one of ultrasonic joining, resistance welding, and laser welding.

According to the above structure, it is possible to provide a joining structure and a joining method of a terminal and a cable, which can reduce, at a low cost, fracturing of a core wire and joint failures during joining.

### BRIEF DESCRIPTION OF THE DRAWINGS

FIG. 1 is a plan view showing an example of a joining structure of a terminal and a cable according to a first embodiment;

FIG. 2A is a side view of the joining structure of the terminal and the cable;

FIG. 2B is a side view of a joining structure of a terminal and a cable of a reference example;

FIGS. 3A and 3B are side views showing a joining method of a terminal and a cable according to the first embodiment in sequence; and

FIGS. 4A, 4B, and 4C are side views showing a joining method of a terminal and a cable according to a second embodiment in sequence.

### DETAILED DESCRIPTION

Hereinafter, a joining structure and a joining method of a terminal and a cable according to embodiments of the present disclosure will be described in detail with reference to the drawings.

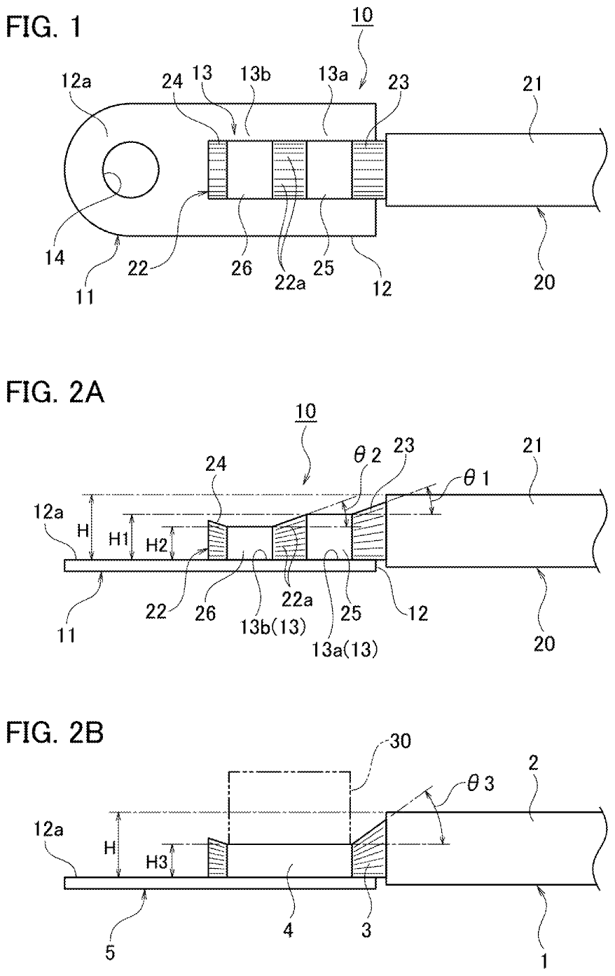

As shown in FIGS. 1 and 2A, a joining structure 10 of a terminal and a cable includes a terminal 11 and a cable 20. A core wire 22 exposed from an insulation sheath 21 of the cable 20 is electrically connected to the terminal 11 by means of ultrasonic joining.

As shown in FIGS. 1 and 2A, the terminal 11 is formed of a rectangular plate-shaped base plate 12 which is made of metal. The terminal 11 has a joining surface 13 in which joining portions 25 and 26 of the core wire 22 are ultrasonically joined to an upper surface 12a of the base plate 12, and which enables electrical connection between the terminal 11 and the core wire 22. The joining surface 13 has a joining surface 13a on the proximal end side of the core wire 22 in the longitudinal direction, and a joining surface 13b on a distal end side of the core wire 22 in the longitudinal direction.

As shown in FIG. 1, the base plate 12 has a circular mounting hole 14 at the center of a semicircular plate-like portion at the distal end portion of the base plate 12. Through the mounting hole 14, a bolt or screw for connecting the terminal 11 to a to-be-connected portion is inserted. A specific material for forming the base plate 12 includes copper or a copper alloy containing copper as a main component, aluminum or an aluminum alloy containing aluminum as a main component, or the like.

As shown in FIGS. 1 and 2A, the cable 20 has a structure in which the core wire 22 formed of a plurality of element wires 22a is sheathed with the insulation sheath 21. At the distal end side of the cable 20, the insulation sheath 21 is peeled off, and thus a part of the core wire 22 is exposed. The exposed core wire 22 on the distal end side of the cable 20 is brought into contact with the joining surface 13a on the proximal end side and the joining surface 13b on the distal end side of the terminal 11. The exposed core wire 22 on the distal end side of the cable 20 has an exposed end portion 23 on the proximal end side and an exposed end portion 24 on the distal end side.

As shown in FIG. 1, the exposed end portion 23 on the proximal end side of the core wire 22 is ultrasonically joined (pressure-welded) to the joining surface 13a on the proximal end side of the terminal 11, and accordingly a joining portion 25 on the proximal end side is formed. Further, the exposed end portion 24 on the distal end side of the core wire 22 is ultrasonically joined (pressure-welded) to the joining surface 13b on the distal end side of the terminal 11, and accordingly a joining portion 26 on the distal end side is formed. The joining portion 25 on the proximal end side and the joining portion 26 on the distal end side are provided with a predetermined interval L between each of them, the predetermined interval L being in the longitudinal direction of the core wire 22. Further, the height H2 of the joining portion 26 on the distal end side is formed to be lower than the height H1 of the joining portion 25 on the proximal end side. The height H2 is the thickness of the joining portion 26 from the upper surface 12a in a direction perpendicular to the joining surface 13b of the terminal 11 and in the vertical direction in FIG. 2A. The height H1 is the thickness of the joining portion 25 from the upper surface 12a in a direction perpendicular to the joining surface 13a of the terminal 11, and in the vertical direction in FIG. 2A. That is, the height H of the core wire 22 before being joined (the exposed end portion 23 on the proximal end side) is the highest (the height H is the thickness of the cable 20 from the upper surface 12a in a direction perpendicular to the upper surface 12a of the terminal 11 and in the vertical direction in FIG. 2A). Compression ratios increase in the order from the joining portion 25 on the proximal end side to the joining portion 26 on the distal end side. Therefore, each height becomes shorter in the same order as above (H>H1>H2). A specific material of the core wire 22 includes copper or a copper alloy containing copper as a main component, aluminum or an aluminum alloy containing aluminum as a main component, or the like.

In the joining structure 10 of the terminal 11 and the cable 20 of the first embodiment described above, as shown in FIG. 2A, the height H1 of the joining portion 25 on the proximal end side is set to be lower than the height H of the exposed end portion 23 on the proximal end side. This can reduce an angle θ1 formed between the exposed end portion 23 on the proximal end side and an end portion of the joining portion 25 on the proximal end side. Similarly, the height H2 of the joining portion 26 on the distal end side is set to be lower than the height H1 of the joining portion 25 on the proximal end side. This can reduce an angle θ2 formed between end portions of the joining portion 25 on the proximal end side and the joining portion 26 on the distal end side. As described above, since it is possible to reduce a core wire angle in the vicinity of the end portions of the joining portions 25 and 26 to be ultrasonically joined, stress concentration is reduced and the core wire 22 is less likely to fracture (break).

More specifically, as in the case of a reference example shown in FIG. 2B, most of the core wire 3 exposed from the insulation sheath 2 of the cable 1 up to about the height H3, which is half the height of the core wire 3, is pressure-welded all at once. Therefore a large angle θ3 is formed between a portion of the core wire 3 which is on the proximal end side and close to the insulation sheath 2 and the end portion of the joining portion 4. As a result, stress is concentrated on the end portion of the joining portion 4 joined to the terminal 5, and the core wire 3 is easily severed (breaks). Meanwhile, in the first embodiment, the joining portions 25 and 26 are provided with the predetermined interval L in the longitudinal direction of the core wire 22 therebetween, and the height of each of the joining portions 25 and 26 is gradually reduced. This can prevent, at a low cost, the core wire 22 from breaking due to severing or the like during ultrasonic joining. Further, since the area of each of the joining portions 25 and 26 is smaller than in the past, it is easy to set conditions for uniformly joining the core wire 22 exposed from the insulation sheath 21 to the terminal 11, and incomplete joining is less likely to occur. As described above, there is a technology for joining the core wire 22 exposed from the insulation sheath 21 of the cable 20 to the terminal 11 by means of ultrasonic joining. In this kind of technology, by changing the number of welding processes, the welding position, and the welding height, breaking due to severing or the like of the core wire 22 and joint failures can be prevented at a low cost.

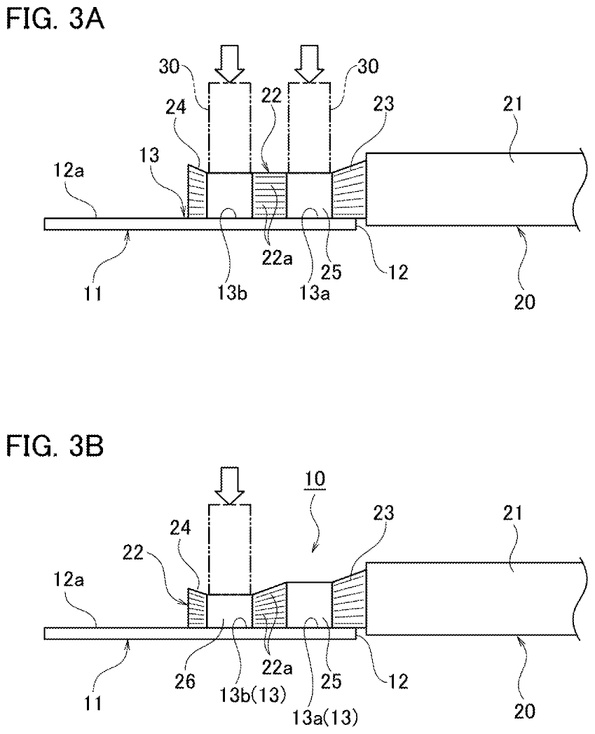

Next, a joining process of the terminal 11 and the cable 20 of the first embodiment will be described in sequence with reference to FIGS. 3A and 3B. In this case, joining is performed by using a welding machine 30 of any one of an ultrasonic joining apparatus, a resistance welding apparatus, and a laser welding apparatus.

As shown in FIG. 3A, the exposed end portion 23 on the proximal end side of the core wire 22 exposed from the cable 20 is pressure-welded/joined to the joining surface 13a on the proximal end side of the terminal 11 once by using the welding machine 30. Accordingly, the joining portion 25 on the proximal end side is formed. At the same time as forming the joining portion 25 on the proximal end side, the exposed end portion 24 on the distal end side of the exposed core wire 22 is pressure-welded once to the joining surface 13b on the distal end side of the terminal 11 by using the welding machine.

Next, as shown in FIG. 3B, the exposed end portion 24 on the distal end side of the exposed core wire 22 which was pressure-welded once to the joining surface 13b on the distal end side of the terminal 11 is pressure-welded/joined to the joining surface 13b once again (that is, pressure-welding is performed a total of two times) by using the welding machine 30. Accordingly, the joining portion 26 on the distal end side is formed.

As described above, a simple operation is performed in which the exposed end portion 23 on the proximal end side and the exposed end portion 24 on the distal end side are simultaneously pressure-welded to the joining surfaces, and only the exposed end portion 24 on the distal end side is pressure-welded to the joining surface again. Accordingly, the terminal 11 and the cable 20 can be electrically connected at a low cost and in a short time without severing the core wire 22.

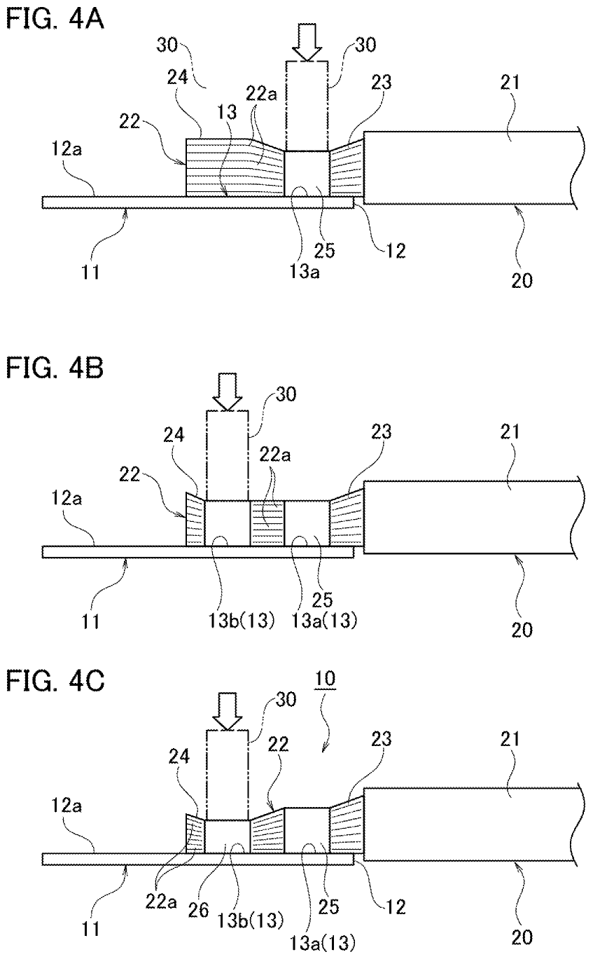

Each of FIGS. 4A, 4B, and 4C is a side view showing a joining method of a terminal and a cable according to a second embodiment of the present disclosure in sequence.

A joining method of a terminal 11 and a cable 20 of the second embodiment differs from the joining method of the terminal 11 and the cable 20 of the first embodiment in that an exposed end portion 24 on the distal end side is joined after an exposed end portion 23 on the proximal end side of an exposed core wire 22 is joined. Since configurations other than the above of the second embodiment are the same as those of the first embodiment, the same components are denoted with the same reference numerals and a detailed description thereof is omitted.

A joining process of the terminal 11 and the cable 20 of the second embodiment will be described in sequence with reference to FIGS. 4A, 4B, and 4C. In this case, joining is performed by using a welding machine 30 of any one of an ultrasonic joining apparatus, a resistance welding apparatus, and a laser welding apparatus.

As shown in FIG. 4A, the exposed end portion 23 on the proximal end side of the core wire 22 exposed from the cable 20 is pressure-welded/joined to a joining surface 13a on the proximal end side of the terminal 11 once by using the welding machine 30. Accordingly, a joining portion 25 on the proximal end side is formed.

Next, as shown in FIG. 4B, the exposed end portion 24 on the distal end side of the exposed core wire 22 of the cable 20 is pressure-welded once to a joining surface 13b on the distal end side of the terminal 11 by using the welding machine 30.

Next, as shown in FIG. 4C, the exposed end portion 24 on the distal end side, which was pressure-welded once to the joining surface 13b on the distal end side of the terminal 11 is pressure-welded/joined to the joining surface 13b once again (that is, pressure-welding is performed a total of two times) by using the welding machine 30. Accordingly, a joining portion 26 on the distal end side is formed. By electrically connecting the terminal 11 and the cable 20 through these steps, the same operation and effect as in the first embodiment can be achieved.

Although the present embodiment has been described above, the present embodiment is not limited thereto, and various modifications can be made within the scope of the gist of the present embodiment.

That is, according to the embodiments, a core wire exposed from an insulation sheath of a cable is electrically connected to a joining surface of a terminal at two joining portions that are a joining portion on the proximal end side and a joining portion on the distal end side. However, a core wire exposed from an insulation sheath of a cable may be electrically connected to a joining surface of a terminal at three or more joining portions.

According to the embodiments, joining is performed in the order from an exposed end portion on the proximal end side to an exposed end portion on the distal end side of a core wire exposed from an insulation sheath of a cable. However, alternatively, joining may be performed in the order from an exposed end portion on the distal end side to an exposed end portion on the proximal end side of an exposed core wire.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A joining structure of a terminal and a cable for joining a core wire exposed from an insulation sheath of the cable to the terminal, wherein
the terminal includes a joining surface to which the exposed core wire is joined;
the exposed core wire includes at least two joining portions; and
the at least two joining portions are formed by being individually joined to the joining surface of the terminal by means of pressure-welding.

2. The joining structure of the terminal and the cable according to claim 1, wherein
the at least two joining portions are provided with a predetermined interval between the at least two joining portions, the predetermined interval being in a longitudinal direction of the exposed core wire.

3. The joining structure of the terminal and the cable according to claim 1, wherein
a height of a joining portion on a distal end side of the at least two joining portions is formed to be lower than a height of a joining portion on a proximal end side.

4. A joining method of a terminal and a cable for joining a core wire exposed from an insulation sheath of the cable to the terminal, the method comprising:
pressure-welding and joining an exposed end portion at least on a proximal end side of the exposed core wire to a joining surface at least on a proximal end side of the terminal once by using a welding machine; and
then pressure-welding and joining an exposed end portion on a distal end side of the exposed core wire to a joining surface on a distal end side of the terminal twice by using the welding machine.

5. The joining method of the terminal and the cable according to claim 4, wherein
when the exposed end portion on the proximal end side of the exposed core wire is pressure-welded to the joining surface on the proximal end side of the terminal, the exposed end portion on the distal end side of the exposed core wire is simultaneously pressure-welded to the joining surface on the distal end side of the terminal once by using the welding machine, and thereafter the exposed end portion on the distal end side of the exposed core wire that has been pressure-welded once to the joining surface on the distal end side of the terminal is pressure-welded and joined to the joining surface once again by using the welding machine.

6. The joining method of the terminal and the cable according to claim 4, wherein
after the exposed end portion on the proximal end side of the exposed core wire is pressure-welded to the joining surface on the proximal end side of the terminal once by using the welding machine, the exposed end portion on the distal end side of the exposed core wire is pressure-welded and joined to the joining surface on the distal end side of the terminal twice continuously by using the welding machine.

7. The joining method of the terminal and the cable according to claim 4, wherein
the exposed end portion of the exposed core wire is joined to the joining surface of the terminal by means of any one of ultrasonic joining, resistance welding, and laser welding.
